(19) United States
(12) Patent Application Publication
(10) Pub. No.: US 2006/0121244 A1
(43) Pub. Date: Jun. 8, 2006

(54) Composite structure with non-uniform density and associated method

(75) Inventors: Grant Godwin, Raleigh, NC (US); Gregory James Solomon, Clayton, NC (US)

Correspondence Address: BARNES & THORNBURG, 11 SOUTH MERIDIAN, INDIANAPOLIS, IN, 46204, US

(73) Assignee: Martin Marietta Materials, Inc.

(21) Appl. No.: 11/289,677

(22) Filed: Nov. 29, 2005

Related U.S. Application Data
(60) Provisional application No. 60/633,018, filed on Dec. 3, 2004.

(51) Int. Cl. B32B 3/10

(52) U.S. Cl. 428/138

(57) ABSTRACT

A composite structure comprises a plurality of fiber insertions spaced relative to one another such that the fiber insertion density is non-uniform. An associated method is disclosed.

This application claims the benefit under 35 U.S.C. § 119(e) of U.S. Provisional Application No. 60/633,018 which was filed Dec. 3, 2004 and is hereby incorporated by reference herein.

### FIELD OF THE DISCLOSURE

The present disclosure relates generally to high strength-to-weight ratio composite materials. More specifically, it relates to high strength-to-weight ratio panels and other structures made of composite materials and methods of making such structures.

### BACKGROUND OF THE DISCLOSURE

Composite structures typically include a reinforcing agent in a matrix. The reinforcing agent provides the main mechanical strength of the structure while the matrix operates to bind the reinforcements together.

### SUMMARY OF THE DISCLOSURE

According to an aspect of the disclosure, a high strength-to-weight ratio composite structure comprises a plurality of fiber insertions. The fiber insertions are spaced relative to one another to provide the composite structure with a non-uniform density of fiber insertions. Areas of higher fiber insertion density promote the stiffness and load-bearing capacity of such areas. An associated method of making the composite structure is disclosed.

Illustratively, the composite structure may be embodied, for example, as a sandwich panel or as one or more solid laminate sheets. In the case of a panel, the panel has a composite first skin, a composite second skin, a core sandwiched between the first and second skins, and a plurality of fiber insertions, each of which extends at least partially through the first skin, the core, and the second skin. The fiber insertions are spaced relative to one another such that the density of the fiber insertions in the panel is non-uniform. Each skin or each sheet (in the case of one or more solid laminate sheets) may have a plurality of fiber layers extending substantially along perpendicular x and y axes and through which the fiber insertions extend along a z axis perpendicular to the x and y axes.

### BRIEF DESCRIPTION OF THE DRAWINGS

FIG. 1 is a fragmentary perspective view partially cutaway of a high strength-to-weight ratio composite structure comprising a plurality of fiber insertions located between upper and lower skins and positioned relative to one another to provide the structure with a lower fiber density area and a higher fiber density area;

FIG. 2 is a perspective view showing the structure of FIG. 1 configured as a panel having a number of higher fiber density areas;

FIG. 3 is a perspective view of the composite panel showing a fastener extending through each of the higher fiber density areas;

FIG. 4 is a fragmentary cross sectional view taken along lines 4-4 of FIG. 3 showing a fastener extending through one of the higher fiber density areas;

FIG. 5 is a side elevation view showing the composite panel positioned for use as a platform;

FIG. 6 is a graphical representation of a density analysis for one embodiment of a higher fiber density area of the composite panel;

FIG. 7 is a graphical representation of a higher fiber density area and a lower fiber density area during manufacture of the composite panel;

FIG. 8 is a diagrammatic view of an apparatus for making the composite panel;

FIGS. 9a-9d represent views of inserts which reinforce the composite material; and

FIGS. 10a-10c are elevational views showing variation in the density of fiber insertions in a sandwich panel (FIG. 10a), a single laminate sheet (FIG. 10b), and a plurality of laminate sheets (FIG. 10c) secured to one another.

### DETAILED DESCRIPTION OF ILLUSTRATIVE EMBODIMENTS

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives falling within the spirit and scope of the disclosure.

The present disclosure relates to a composite material and a composite panel incorporating the composite material for use as a structural support. In one embodiment, the composite panel is configured, for example, as a sandwich panel having a core and two skins (e.g., two laminated skins) secured to opposite sides of the core. Such a composite panel may be fabricated in a continuous manner. In one embodiment, the composite material may be formed to have a non-uniform or variable density. As such, the composite material may have one or more lower density areas and may have one or more higher density areas for use with higher loads.

One exemplary type of composite panel is a fiber reinforced panel (FRP panel). Such an FRP panel may be formed of a polymer matrix composite material which includes a reinforcing element and a polymer resin. The FRP panel may be embodied as any type of FRP structure. Examples of such structures include, but are not limited to, a solid laminate or a pultruded or vacuum-infused sandwich panel (e.g., a panel having upper and lower skins with a core therebetween). In the case of where the FRP panel is embodied as a sandwich panel, the core type may include, but is not limited to, wood, foam and various types of honeycomb.

The matrix may include a thermosetting resin. Examples of thermosetting resins which may be used include, but are not limited to, unsaturated polyesters, vinyl esters, polyurethanes, epoxies, phenolics, and mixtures and blends thereof. It is within the scope of this disclosure for the matrix to include thermoplastic resins.

The reinforcing element may include E-glass fibers, although other reinforcements such as S-glass, carbon, KEVLAR®, metal (e.g., metal nano-fibers), high modulus organic fibers (e.g. aromatic polyamides, polybenzamidazoles, and aromatic polyimides), and other organic fibers (e.g. polyethylene and nylon) may be used. Blends and hybrids of such materials may be used for the reinforcing element. Other suitable composite materials may be used for the reinforcing element including whiskers and fibers such as boron, aluminum silicate, and basalt.

The FRP panel may be embodied as any of the structures disclosed in U.S. Pat. Nos. 5,794,402; 6,023,806; 6,044,607; 6,070,378; 6,081,955; 6,108,998; 6,467,118 B2; 6,645,333; 6,676,785, the entirety of each of which is hereby incorporated by reference.

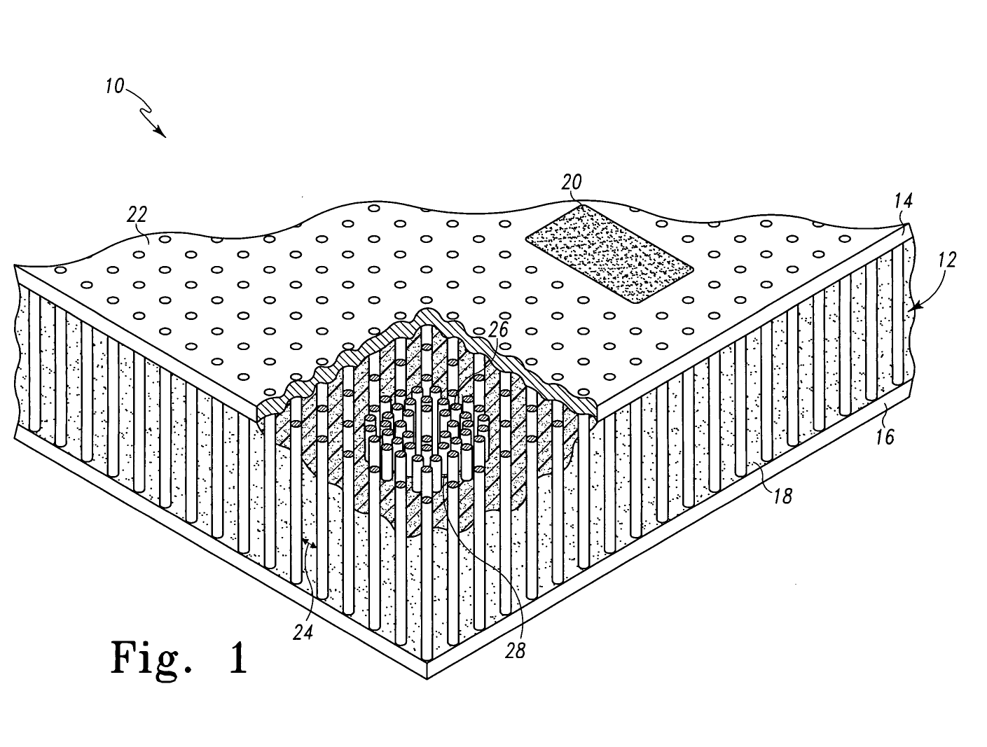

Referring to FIG. 1, a composite structure 10 is configured as a sandwich comprising a plurality of fiber insertions 12, skins 14, 16, and a core 18. Each skin 14, 16 comprises at least one two-dimensional fabric fiber layer. The core 18 is sandwiched between the pair of skins 14, 16. During the panel fabrication process, fiber insertions 12 are inserted through the skins 14, 16 and the core 18 located therebetween to provide a “dry sandwich.” Subsequently, resin is introduced to surfaces of the dry sandwich and travels through the sandwich via vacuum pressure. As described herein, each fiber insertion 12 may represent a bundle of fiber elements associated with each other as known in the art.

One or more covers 20 may be secured to the skins 14, 16 of the composite structure 10. The covers 20 may be embodied as a variety of materials including, for example, metal sheets and/or any one or more of a variety of gels or other coating materials that provide, for example, weather protection or friction surfaces. Moreover, different types of covers may be used to cover the skins 14, 16. For example, an exterior cover 20 may be finished in a predetermined, desired exterior color to facilitate display of indicia markings. Similarly, interior covers 20 may be finished in a predetermined color different from the desired exterior color. The covers 20, the skins 14, 16, and the core 18 may be co-cured with one another.

The composite structure 10 includes at least one lower fiber density area 22 in which the fiber insertions 12 thereof are positioned relative to one another to provide each lower fiber density area 22 with a lower fiber density. The fiber insertions 12 of each area 22 may be spaced relative to one another by a spacing 24. In an embodiment, the spacing 24 is uniform. Exemplarily, the spacing 24 is such that each area 22 has sixteen fiber insertions per square inch.

The composite structure 10 also includes at least one higher fiber density area 26 in which the fiber insertions 12 thereof are positioned relative to one another to provide each higher fiber density area 26 with a higher fiber density greater than the lower fiber density. In each area 26, the fiber insertions 12 are spaced relative to one another by a spacing 28. The higher fiber density areas 26 may include a greater number of fiber insertions 12 as compared to the number of fiber insertions 12 in lower fiber density areas 22.

In an embodiment, the spacing 28 of each area 26 may be non-uniform. As such, the fiber insertions 12 disposed within each area 26 may be non-uniformly or variably spaced relative to one another.

In another embodiment, the spacing 28 of an area 26 may be uniform. As such, the fiber insertions 12 disposed within an area 26 may be uniformly spaced relative to each other.

In still another embodiment, the spacing between fiber insertions 12 within one or more areas 26 may be different from the spacing between fiber insertions 12 within one or more other areas 26. As such, the fiber insertions 12 disposed within one or more areas 26 may be non-uniformly or variably spaced relative to the fiber insertions 12 disposed in one or more other areas 26.

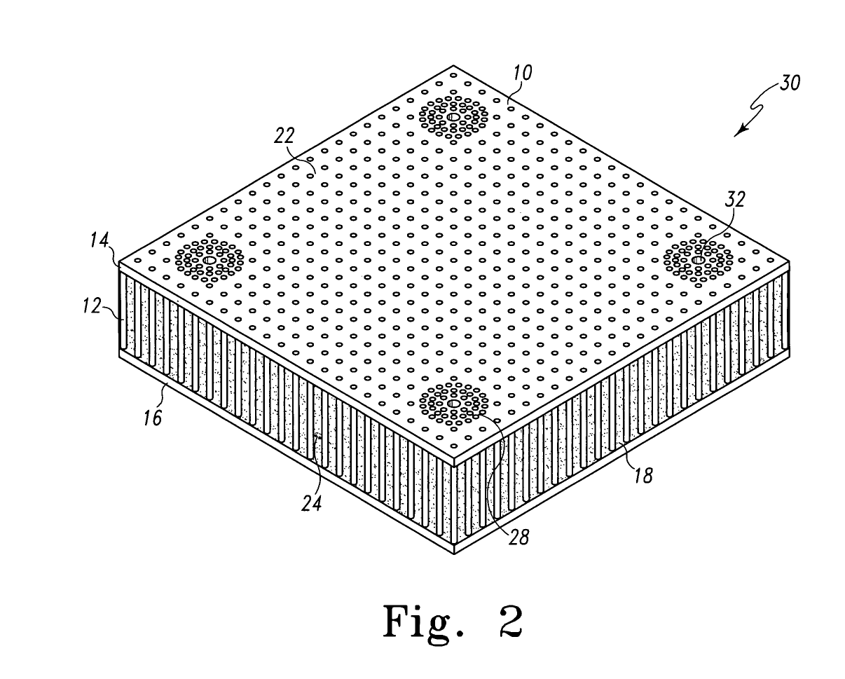

Referring to FIG. 2, the composite structure 10 may be configured as a composite panel 30. In such a configuration, the panel 30 is configured as a sandwich panel comprising the fiber insertions 12, skins 14, 16, and core 18 sandwiched. The panel 30 further comprises the at least one lower fiber density area 22 having a lower fiber density and the spacing 24 (which, illustratively, is uniform). The panel 30 also comprises the at least one higher fiber density area 26 having a fiber density greater than the lower fiber density and having the spacing 28. Additionally, the higher fiber density areas 26 may be uniformly or non-uniformly positioned relative to one another within the panel 30.

Higher fiber density areas 26 may be located in regions that may experience increased stress. Such increased stress may occur in a variety of locations and for a variety of reasons. Exemplarily, an area 26 may be used in the vicinity of a fastener 34 or other connector. In another example, one or more higher fiber density areas 26 may be located along one or more edges of the panel 30. The resultant stiffening of the edge(s) may promote attachment of the stiffened edge(s) to other structures.

Illustratively, the panel 30 may comprise a plurality of holes in the form of, for example, cavities 32 disposed through the panel 30. The plurality of cavities 32 may be positioned in association with the plurality of higher fiber density areas 26. The cavities 32 relate to increased stress or load areas of the panel 30 as will be discussed. In an embodiment, an individual cavity 32 may be centrally positioned within a respective area 26.

The cavity 32 may be formed in a variety of ways. One method of forming the cavity 32 through the panel 30 is to drill the cavity 32. The cavity 32 may also be formed as part of the continuous panel fabrication process. The cavity 32 may also be formed by inserting a form in the core 18 wherein the form may be embodied as a tube, square or other geometrically or irregularly shaped configuration.

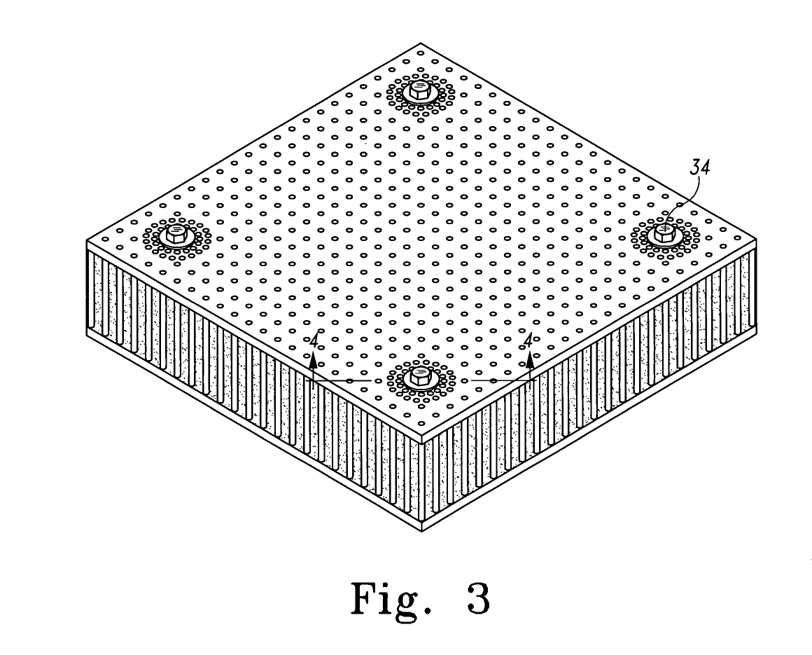

Referring to FIGS. 3 and 4, a fastener 34 such as a bolt is positioned through each cavity 32. Accordingly, the cavity 32 is configured to guide the fastener 34 through the panel 30. The fastener 34 may be used to attach the panel 30 to a structure (not shown).

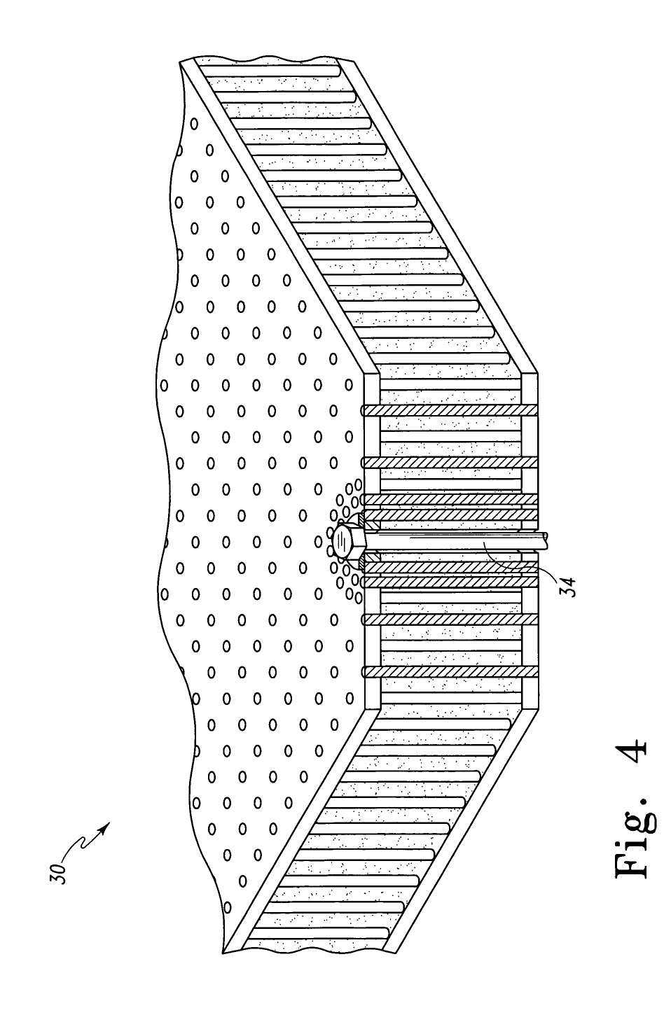

Referring to FIG. 5, the panel 30 may be used to provide a support for a load such as a uniform load or a non-uniform load. The panel 30 may be positioned in contact with structures 36, 40. Fasteners 34 may connect panel 30 to structures 36, 40. Higher fiber density areas 26 receive the fasteners 34 and provide the stifffiess to respond to loads (e.g., “rip out” and shear loads) applied to the panel 30 due to fasteners 34. As such, the areas 26 stiffen the panel 30 against forces of the fasteners 34. Accordingly, the areas 26 limit damage, wear and/or corrosion that may otherwise be caused by the fasteners 34.

The areas 26 positioned over the structures 36, 40 may be adhered to the structures 36, 40 by use of an adhesive (not shown) in lieu of or in addition to use of the fasteners 34. In such a case, the increased stiffness of the area 26 promotes the adhesive connection between the area 26 and the structure 40.

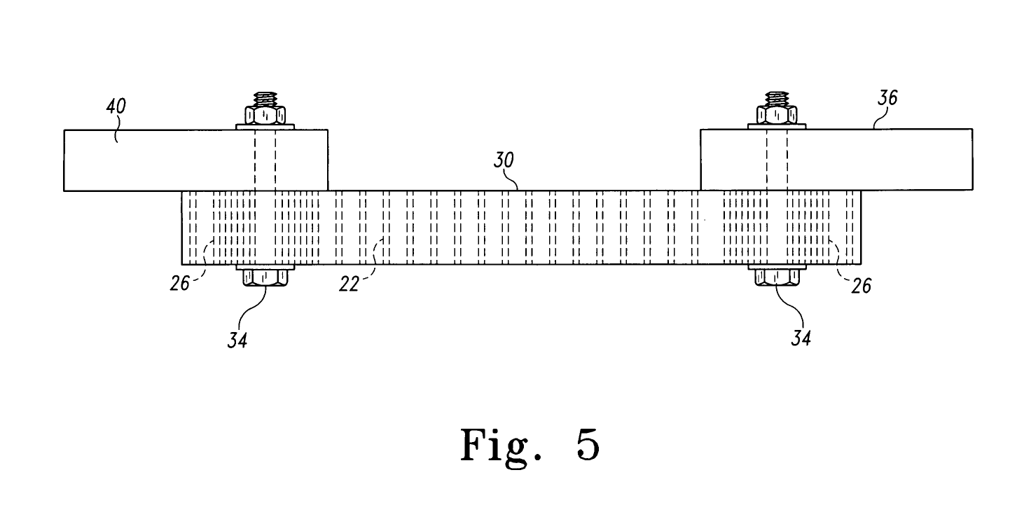

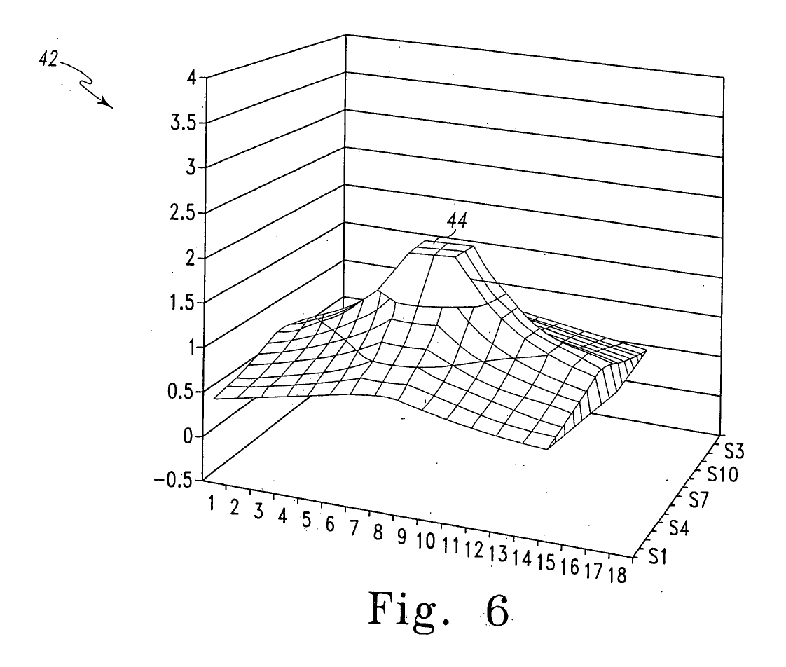

Referring to FIG. 6, a method of manufacturing the panel 30 comprising the structure 10 is illustrated. In designing the panel 30, the location of increased load areas is determined. An increased load area may represent a position on the panel 30 having a fastener 34, such as a bolt, extending therethrough. Once the position of the increased load area is determined, a fiber density analysis 42 is performed to integrally determine the load points applied to the panel 30 and the corresponding required fiber density as shown, for example, in FIG. 6. A computer modeling program which calculates loads and corresponding fiber density data while issuing commands in the form of, for example, density data signals to an associated fiber deposition machine may be used to perform the density analysis 42. As illustrated in the density analysis 42 shown in FIG. 6, the density of fiber insertions 12 increases to a central area 44 representing the applied load. Based on the density analysis 42, the location, size, and/or configuration of the lower fiber density areas 22 and the higher fiber density areas are determined for proper positioning within the panel 30.

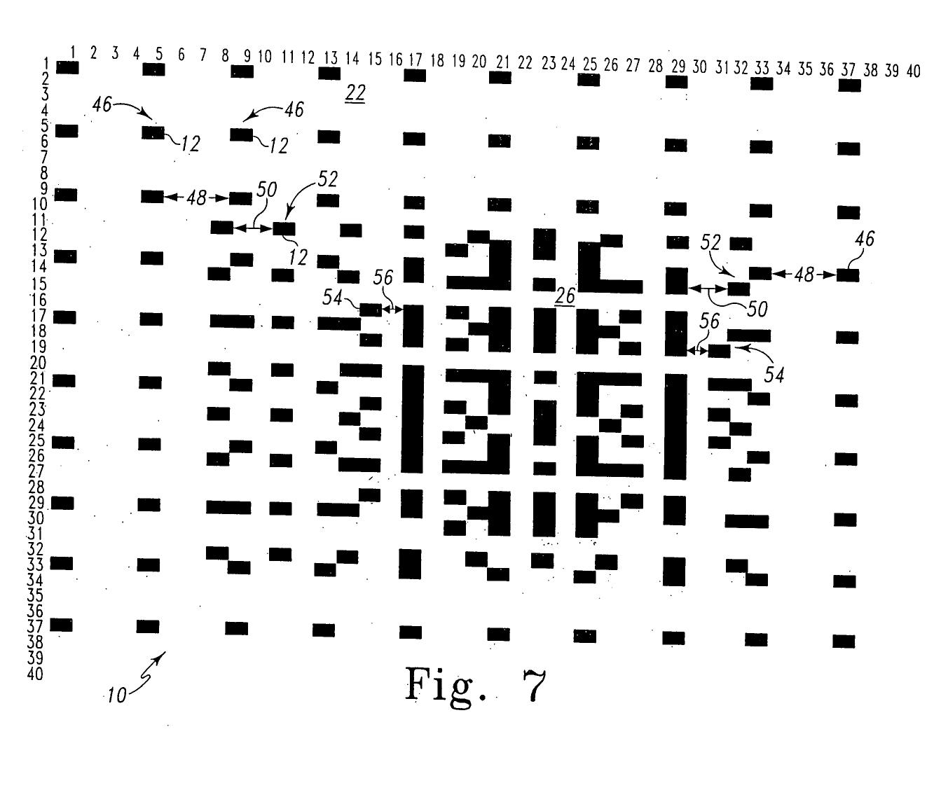

Referring to FIG. 7, after completion of the density analysis 42, density data is communicated to the fiber deposition machine by, for example, one or more density data signals. An exemplary fiber deposition machine is disclosed in U.S. Pat. No. 6,645,333. A module of the fiber deposition machine begins inserting columns 46 of fiber insertions 12 into the skins 14, 16 and core 18 of the composite structure 10 to form lower fiber density area 22. In area 22, the columns 46 may include a constant number (e.g., ten) of fiber insertions 12. After the module deposits a column 46 of fiber insertions 12, the composite structure 10 is advanced linearly a predetermined distance 48 with respect to the module. The module then deposits another column 46 of fiber insertions 12 to continue configuring the lower fiber density area 22. This fiber deposition process repeats to continue forming the uniform density area 22 until the module begins depositing a higher fiber density area 26 within the composite structure 10.

In one embodiment, to form a higher fiber density area 26, the composite structure 10 is advanced linearly another predetermined distance 50 which may be less than distance 48. Upon advancement of the composite structure 10, the module deposits a column 52 of fiber insertions 12. In area 26, the columns 52 may include a constant number of fiber insertions 12. The number of fiber insertions 12 in a column 52 may be more or less than the number of fiber insertions 12 in a preceding column 52. The fiber deposition process advances the composite structure 10 and deposits fiber 12 as desired to create the area 26.

The fiber deposition machine may deposit additional columns 54 of fiber insertions 12 at predetermined distances 56. In an embodiment, the number of fiber insertions 12 in a column 54 may be less than or greater than the number of fiber insertions 12 in another column 54. This fiber deposition sequence continues depositing fiber insertions 12 until the fiber deposition machine has completed the desired pattern of the fiber insertions 12.

Based on the density analysis 42, the fiber deposition machine may configure the higher fiber density areas 26 as a uniform or non-uniform configuration by varying the deposition of fiber insertions 12 in columns 52, 54. The present disclosure is not limited to columns 46, 52, and 54, but may include additional columns of fiber insertions 12 as required by the density analysis 42. After depositing the calculated lower fiber density areas 22 and higher fiber density areas 26, the fiber deposition machine processes the composite structure 10 into a desired shape to form the panel 30.

In an embodiment, the fiber deposition machine comprise a plurality of rows of modules to deposit fiber insertions 12 into the composite structure 10. In this embodiment, different modules are used to deposit different columns of fiber insertions 12. Still further in this embodiment, a sequence program having a timing function to coordinate activation of the plurality of modules may be used to control the advancement of the composite structure 10 and the distancing of fiber columns deposited by associated modules.

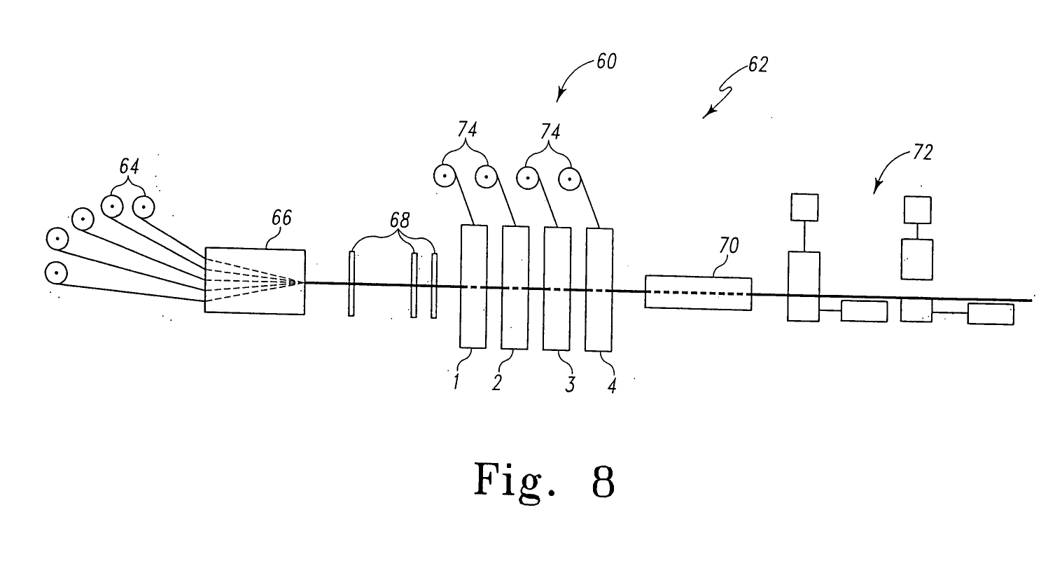

Referring to FIG. 8, the fiber deposition machine designated by 60 may be included in an exemplary pultrusion process 62. In such a case, fiber layers in the form of, for example, woven roving are supplied by fabric rolls 64 to form the layers of skins 14, 16 in the case of a panel or a laminate sheet in the case of a solid laminate. The layers pass through a resin tank 66 where the fiber layers are wetted with resin. In the case of a panel, the core 18 may be introduced between the skins 14, 16 before or after the tank 66. In either case, the wetted unit may be advanced through debulking bushing 68 to remove excess resin. Next, the fiber deposition machine 60 inserts the fiber insertions 12 and the unit is then cured at a heated die 70. The structure 10 is pulled along the passline by a puller 72 in the form of, for example, a pair of illustrated grippers or rollers. In another example, the fiber insertions 12 may be added upstream of the resin tank 66.

The fiber deposition machine 60 may comprises four rows of modules 1, 2, 3, and 4. The modules 1, 2, 3, 4 receive the fiber insertion material from associated rolls 74. The four rows of modules 1, 2, 3, 4 insert fiber insertions 12 in four associated columns. The composite structure 10 is then advanced and the rows insert fiber insertions 12 in four more columns. The sequence continues until completion of the desired fiber pattern. The rows may insert the fiber insertions 12 in the corresponding columns simultaneously before advancement to the next set of columns. In one example, rows 1, 2, 3, and 4 insert fiber insertions 12 in columns 1, 2, 3, and 4, respectively. The composite structure 10 is advanced four steps (each step being associated with a column) and rows 1, 2, 3, and 4 insert columns 5, 6, 7, and 8, respectively. This sequence repeats itself until completion of the fiber pattern. In another example, rows 1, 2, 3, and 4 insert fiber insertions 12 in non-adjacent columns such as columns 1, 14, 27, and 30.

In one embodiment, one row of modules (e.g., row 1) is designated as the master row. The other rows are called slaves. In contrast to the master row, the slave rows are located on gantries that can traverse a number of columns. For instance, the rows may be spaced four columns apart and the slaves may traverse +/− three columns. In such a case, master row 1 may insert column 1 and slave rows 2, 3, and 4 may insert columns 5, 9, and 13. The composite structure 10 may be advanced one step at a time until three such single-step advancements are completed. At the next advancement, the composite structure 10 may be advanced 12 steps.

The master row is selected to be, for example, the row with the longest insertion time when the rows operate simultaneously. The insertion time is, for example, the time for each insertion plus travel time multiplied by the number of insertions per column. The fiber deposition machine may be programmed to advance the composite structure 10 relative to the master row upon completion of a column by the master row. Use of such a procedure may simplify programming of the software for the fiber deposition machine.

The position of each slave row may be gauged by a variety of methods such as “absolute distance” or “relevant distance.” With respect to “absolute distance,” each slave row is measured from the master row. With respect to “relevant distance,” a reference point located a fixed distance from the master row is selected and the distance from each slave row to the reference point is determined.

The position of all the rows (i.e., master and slave rows) may be gauged by use of another technique. In particular, the position of each row may be gauged by having each row work off of a mark on an inserted fabric. By gauging the distance away from each mark, it is possible to provide each row in the desired pattern.

According to another method of creating a variable density pattern, each row is responsible for inserting a selected color of fibers or is dormant. For example, rows 1, 2, and 3 insert red fiber insertions, blue fiber insertions, and black fiber insertions, respectively, while row 4 is dormant.

There are at least three ways for dealing with the situation in which two or more fiber insertions 12 are planned to be inserted into the same place. First, the two or more fiber insertions 12 may be inserted into the same place. Second, the two or more fiber insertions 12 may be inserted with a slight offset from one another to avoid interference with previous fiber insertions. Third, only one row (e.g., the master row) may be used to make the fiber insertion.

In another embodiment, while the master row is making insertions, each slave row works ahead so as to insert fiber insertions 12 into multiple positions within its range of traverse. The slave rows stop when the master row stops to allow the panel 30 to be advanced.

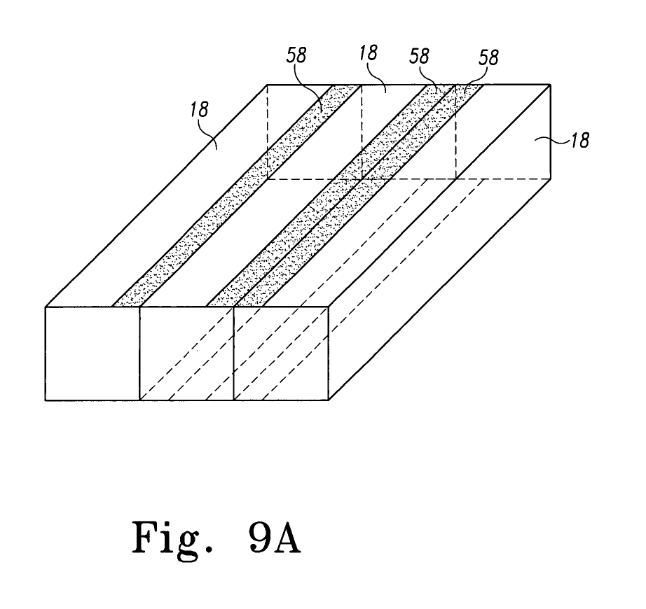

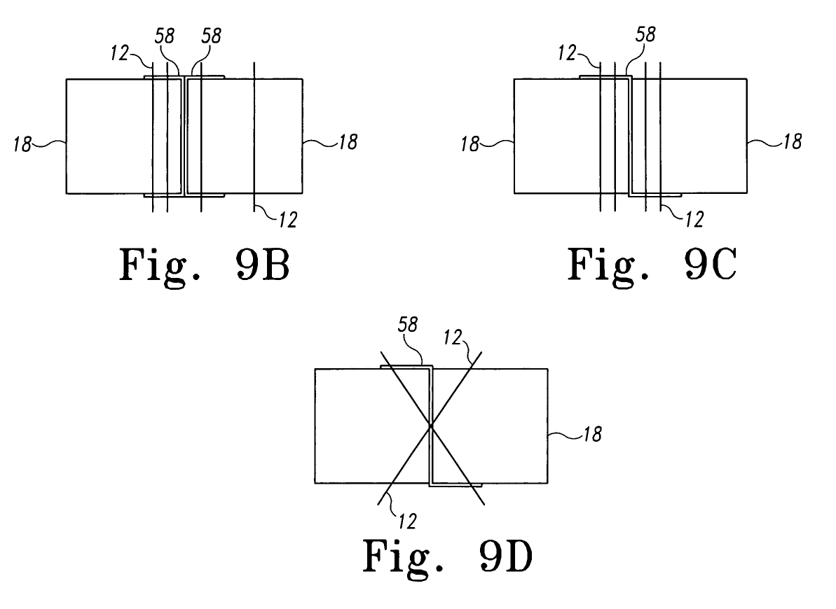

Referring to FIGS. 9a-9d, during manufacturing of the composite structure 10, a fabric insertion 58 may be inserted into contact with the core 18 prior to inserting the core 18 between the skins 14, 16. The fabric insertion 58 provides strength reinforcement for the panel 30.

Turning to FIG. 9a, a plurality of cores 18 are shown in a perspective view. In an embodiment, the fabric insertion 58 may extend along the length of the core 18. In another embodiment, the fabric insertion 58 may partially extend along the length of the core 18. Still further in an embodiment, the fabric insertion 58 may contact more than one core 18. Additionally, in an embodiment, the fabric insertion 58 may wrap around the entire core 18.

Turning to FIG. 9b, which illustrates a partial cross sectional view of FIG. 8a, two fabric insertions 58 are shown associated with adjacent cores 18 to form an I-shaped configuration. In this configuration, each fabric insertion 58 contacts a specific core 18. The fiber insertions 12 may be inserted through the fabric insertion 58 and into the core 18.

Turning to FIG. 9c, which illustrates a partial cross sectional view of FIG. 8a, a fabric insertion 58 is shown associated with adjacent cores 18 to form a Z-shaped configuration. In this configuration, the fabric insertion 58 contacts both cores 18. As illustrated, the fabric insertion 58 may extend along the top of one core 18 and may extend along the bottom of the adjacent core 18.

Turning to FIG. 9d, the fiber insertions 12 may be inserted through the core 18 and even fabric insertion 58 at an angle.

The fiber insertions 12 may be inserted into each core 18 to provide the core 18 with a variable fiber density as disclosed herein.

During manufacture of the structure 10, the core 18 having fabric insertion 58 may be positioned within the composite structure 10 either linearly or crosswise to allow increased stiffness throughout the composite structure 10. Once the core 18 and fabric insertion 58 are positioned within the composite structure 10, the fiber deposition machine may deposit fiber insertions 12 through the fabric insertion 58 and into the core 18.

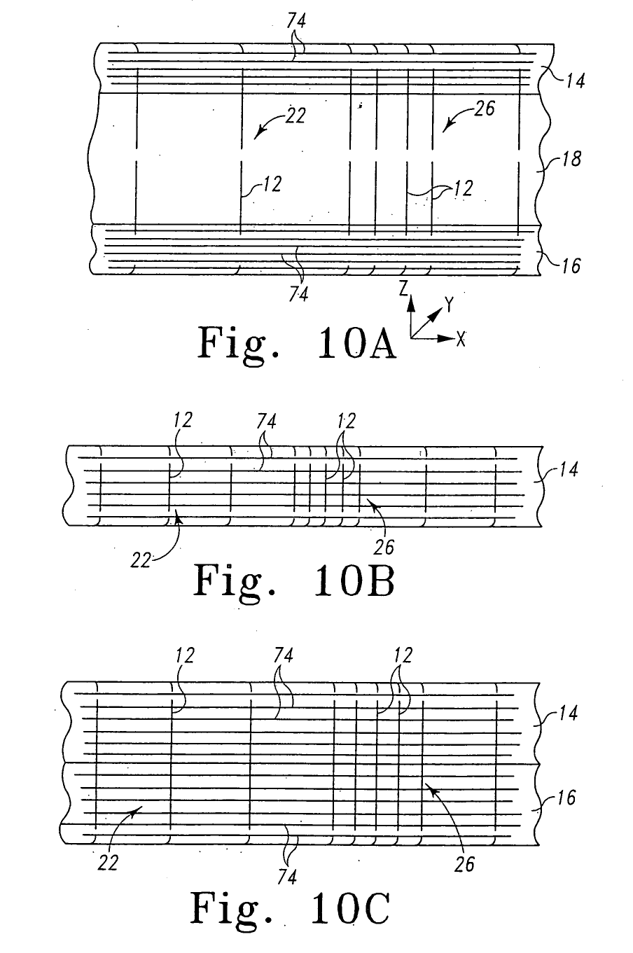

Referring to FIG. 10A, there is shown the panel 30 with the composite laminate skins 14, 16, the core 18 sandwiched between the skins 14, 16, and the plurality of fiber insertions 12. The skins 14, 16 have fiber layers 74 which extend substantially along x and y axes to provide 2-dimensional reinforcement. The x axis is horizontal on the page of FIG. 10A, the y axis extends into the page of FIG. 10A, and the z axis is vertical on the page of FIG. 10A. Each fiber insertion 12 extends substantially along the z axis at least partially through the skins 14, 16 and the core 18. More specifically, each fiber insertion 12 extends transversely through the fiber layers 74 to provide one-dimensional reinforcement of the panel 30. As such, the panel 30 is reinforced in three spatial dimensions. The fiber insertions 12 are spaced relative to one another such that the density of the fiber insertions 12 is non-uniform. For example, the density of the fiber insertions 12 in the area 22 is less than the density of the fiber insertions 12 in the area 26.

The fiber insertions 12 may be inserted into at least one solid laminate composite sheet 75 having fiber layers 74 present in a polymer matrix, as shown in FIG. 10B with respect to a single sheet 75 and in FIG. 10C with respect to two sheets 75. Each fiber layer 74 extends substantially along the x and y axes to provide two-dimensional reinforcement and the fiber insertions 12 extend substantially along the z axis through the sheet(s) 75 transversely to and through the fiber layers 74 to provide one-dimensional reinforcement. As such, the sheet(s) 75 is(are) reinforced in three spatial dimensions. The fiber insertions 12 are spaced relative to one another such that the density of the fiber insertions 12 in the sheet(s) 75 is non-uniform.

While the disclosure is susceptible to various modifications and alternative forms, specific exemplary embodiments thereof have been shown by way of example in the drawings and have herein been described in detail. It should be understood, however, that there is no intent to limit the disclosure to the particular forms disclosed, but on the contrary, the intention is to cover all modifications, equivalents, and alternatives falling within the spirit and scope of the disclosure.

There are a plurality of advantages of the present disclosure arising from the various features of the apparatus, systems, and methods described herein. It will be noted that alternative embodiments of the apparatus, systems, and methods of the present disclosure may not include all of the features described yet still benefit from at least some of the advantages of such features. Those of ordinary skill in the art may readily devise their own implementations of apparatus, systems, and methods that incorporate one or more of the features of the present disclosure and fall within the spirit and scope of the present disclosure.

1. A composite panel, comprising:
a composite first skin and a composite second skin,
a core sandwiched between the first and second skins, and
a plurality of fiber insertions, each of which extends at least partially through the first skin, the core, and the second skin, wherein the plurality of fiber insertions are spaced relative to one another such that the density of the fiber insertions is non-uniform.

2. The panel of claim 1, wherein the panel comprises (i) a first area having a plurality of the fiber insertions spaced relative to one another by a first spacing to provide the first area with a uniform first density of fiber insertions, and (ii) a second area having a plurality of the fiber insertions spaced relative to one another by a second spacing to provide the second area with a uniform second density of fiber insertions, the first spacing less than the second spacing such that the first density is greater than the second density.

3. The panel of claim 2, comprising a fastener extending through the first area.

4. The panel of claim 2, comprising a hole extending through the first area.

5. The panel of claim 2, wherein the fiber insertions of the first area define an annular pattern.

6. The panel of claim 1, wherein the density of the fiber insertions is greater in a higher stress area of the panel than a lower stress area of the panel.

7. The panel of claim 1, wherein the density of the fiber insertions is greater in an area of the panel around a fastener extending through the panel than in an area of the panel without any fastener.

8. The panel of claim 1, wherein:
each skin comprises a polymer matrix and at least one fiber layer present in the polymer matrix, and
a plurality of the fiber insertions extend through the at least fiber layer with a non-uniform spacing relative to one another.

9. The panel of claim 1, wherein a plurality of the fiber insertions extend through the core with a spacing non-uniform relative to one another.

10. A composite structure, comprising:
a composite sheet comprising at least one fiber layer extending substantially along perpendicular x and y axes, and
a plurality of fiber insertions extending through the sheet substantially along a z axis perpendicular to the x and y axes such that the plurality of fiber insertions are transverse to the at least one fiber layer, wherein the plurality of fiber insertions are spaced relative to one another such that the density of the fiber insertions in the sheet is non-uniform.

11. The structure of claim 10, wherein the fiber insertions are spaced relative to one another to provide the structure with a first area having a uniform first density of fiber insertions and a second area having a uniform second density of fiber insertions different from the first density.

12. The structure of claim 11, comprising a fastener, wherein:
the first density is greater than the second density, and
the fastener extends through the first area.

13. The structure of claim 10, wherein:
a first number of the fiber insertions is arranged in a first column, and
a second number of the fiber insertions different from the first number is arranged in a second column.

14. The structure of claim 10, comprising a composite second sheet comprising at least one fiber layer extending substantially along the x and y axes, wherein:
the plurality of fiber insertions extend substantially along the z axis through the second sheet and transversely to the at least one fiber layer of the second sheet, and
the fiber insertions are spaced relative to one another such that the density of the fiber insertions in the second sheet is non-uniform.

15. A method of making a composite structure comprising at least one fiber layer extending substantially along x and y axes that are perpendicular to one another and that are perpendicular to a z axis, comprising the steps of:
inserting a plurality of fiber insertions substantially along the z axis and transversely through a first area of the at least one fiber layer such that the fiber insertions of the first area are spaced relative to one another so as to provide the first area with a first density of fiber insertions, and
inserting a plurality of fiber insertions substantially along the z axis and transversely through a second area of the at least one fiber layer such that the fiber insertions of the second area are spaced relative to one another so as to provide the second area with a second density of fiber insertions different from the first density.

16. The method of claim 15, comprising performing the inserting steps in a pultrusion process.

17. The method of claim 15, wherein:
the first inserting step comprises inserting a first number of fiber insertions in a first column, and
the second inserting step comprises inserting a second number of fiber insertions in a second column, the first number different from the second number.

18. The method of claim 17, wherein:
the step of inserting the first number of fiber insertions comprises operating a first fiber insertion module, and
the step of inserting the second number of fiber insertions comprises operating a second fiber insertion module.

19. The method of claim 15, comprising (i) performing a fiber insertion density analysis for the composite structure, (ii) generating a density data signal representative of the results of the analysis, and (iii) operating a fiber deposition machine in response to the density data signal.

20. The method of claim 15, wherein:
the at least one fiber layer is part of a composite laminate first skin of a fiber-reinforced polymer panel comprising a composite laminate second skin and a core sandwiched between the first and second skins,
the first inserting step comprises inserting a plurality of fiber insertions through the first and second skins and the core in a first area of the panel such that the fiber insertions of the first area are spaced relative to one another so as to provide the first area with the first density of fiber insertions, and
the second inserting step comprises inserting a plurality of fiber insertions through the first and second skins and the core in a second area of the panel such that the fiber insertions of the second area are spaced relative to one another so as to provide the second area with the second density of fiber insertions.
